(19) United States
(12) Patent Application Publication
(10) Pub. No.: US 2007/0208743 A1
(43) Pub. Date: Sep. 6, 2007

(54) System and Method For Searching Rights Enabled Documents

(76) Inventor: Narayan Sainaney, Vancouver (CA)

Correspondence Address: GOWLING LAFLEUR HENDERSON LLP (OTT), SUITE 2600, 160 ELGIN STREET, OTTAWA, ON, K1P1C3, CA

(21) Appl. No.: 11/674,138

(22) Filed: Feb. 12, 2007

Related U.S. Application Data
(60) Provisional application No. 60/772,873, filed on Feb. 14, 2006.

(51) Int. Cl. G06F 17/30

(52) U.S. Cl. 707/9

(57) ABSTRACT

A method for searching documents, comprising receiving a users credentials and search criteria for searching a document repository; obtaining a list of documents from the repository which satisfy the search criteria; selecting from the list of documents only those for which the user has been granted permissions in accordance with the users credentials; and presenting the selected list to the user.

### CROSS REFERENCE TO RELATED APPLICATIONS

This application claims the benefit of U.S. Provisional patent application Ser. No. 60/772,873 filed Feb. 14, 2006, the disclosure of which is incorporated herein by reference.

### BACKGROUND OF THE INVENTION

1. Field of the Invention

The present invention relates to a system and method for managing and controlling access to electronic information and electronic documents so that only authorized users may open protected information and documents.

2. Background of the Invention

Search engines such as Google™, and Yahoo™ are the dominant method for locating items on the Internet. Search engines are generally large databases containing information gathered from Web pages using software agents termed web crawlers or spiders. The pages are indexed based on content and the indexes or content and stored in databases which in turn are made available for searching via the search engine interface. The search agents have access to public Web pages; hence current search engines only return results for information that is publicly available on the Web.

Similarly, corporations may deploy search engines on their corporate Intranets or networks, so that users can search for documents that exist within these networks. Typically, documents with restricted access permissions will be located where they cannot be found by search tools, such as private or limited access directories/folders/network locations, or simply because the search engine lacks the necessary permissions to catalog the file contents.

Individuals who do have permission to access these documents lack ability to search for specific documents or portions of text, since the search engine would not have had access to them.

U.S. Pat. No. 6,535,871, addresses one solution to this problem of allowing a restricted document to be searched. A sanitized list of indexed keywords is generated on the restricted document. The sanitized list is made publicly available for searching. Search results are presented to a user. When the user chooses to view the full document that corresponds to a particular search result, the users rights are verified and access to the full document is provided. One of the limitations of this technique relates to the way in which the sanitized index of keywords is created. The keywords have to be carefully chosen so that the index does not reveal sensitive content in the parent document. However in sanitizing the index important keywords may be hidden or excluded from the index, thus a search engine may miss a document even though the content was relevant to the users search criteria.

Accordingly there is a need for a system and method for implementing a rights enabled search process, that at least mitigates the above disadvantages.

### SUMMARY OF THE INVENTION

The present invention provides a process for a search engine to access a series of keywords associated with protected files.

Furthermore, if a search is conducted that generates hits in the protected file's keywords, then these can be reported back to the searcher, who can be advised that that the information requested is available in a file for which the searcher has permissions, or optionally for which they do not, but have a means by which they could obtain them.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 is a block diagram of the major components of an electronic information distribution system according to an embodiment of the invention;

FIG. 2 is a block diagram of the server architecture according to an embodiment of the present invention;

FIG. 3 is a diagram showing a logical view of the server of FIG. 2;

FIG. 4 is flow chart showing an encoding process according to an embodiment of the present invention;

FIG. 5 is a flow chart of an authentication process according to an embodiment of the invention;

FIG. 6 is a flow chart of a document viewing process according to an embodiment of the invention;

FIG. 7 is a ladder diagram showing the authentication process;

FIG. 8 is a ladder diagram of an authentication process in a CRM application according to an embodiment of the present invention;

FIG. 9 shows an infrastructure for implementation of a rights enabled search engine according to an embodiment of the present invention; and

FIG. 10 is a flow chart showing a search process according to an embodiment of the present invention.

In accordance with this invention there is provided a method for searching documents, comprising:

a) receiving a users credentials and search criteria for searching a document repository;

b) obtaining a list of documents from the repository which satisfy the search criteria;

c) selecting from the list of documents only those for which the user has been granted permissions in accordance with the users credentials; and

d) presenting the selected list to the user.

### DETAILED DESCRIPTION OF THE PREFERRED EMBODIMENTS

In the following description like numerals refer to like structures and process in the drawings.

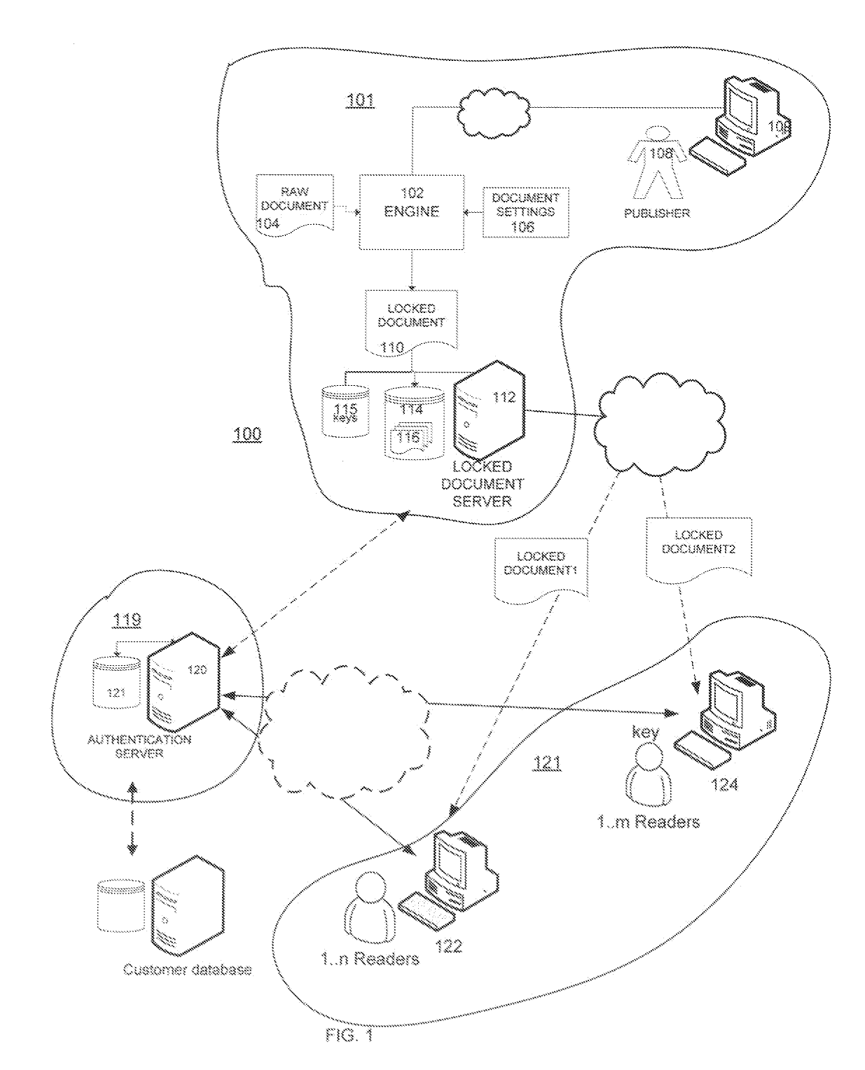

Referring back to FIG. 1, there is shown the general components of a electronic information distribution system 100 according to an embodiment of the present invention. The system 100 of the preferred embodiment is described in terms of a document distribution system can be broken down conceptually into three functional components: an authoring component 101, a viewing component 121 and an authentication server 119.

For convenience, the embodiments described herein are described with respect to a document in the Portable Document Format (PDF) which is a file format developed by Adobe Systems for presentation of documents independent of the original application software, hardware, and operating system used to create those documents. A PDF file can describe documents containing any combination of text, graphics, and images in a device independent and resolution independent format. These documents can vary in length and complexity with a rich use of fonts, graphics, colour, and images. In addition to encapsulating text and graphics, PDF files are most appropriate for encoding the exact look of a document in a device-independent way. In contrast, markup languages such as HTML defer many display decisions to a rendering device such as a browser, and will not look the same on different computers.

Free document viewers for many platforms are available. At creation time the author may include code or scripts within the document executable by the document viewer. These codes and scripts may for example, restrict viewing, editing, printing or saving. It is assumed that PDF files are capable of being created with embedded codes or scripts, that in turn can be executed or read by the document viewer and that the recipient is not able to access or change these scripts or codes unless authorised to do so.

The authoring component 101 includes a document creation engine 102 for creating protected documents 116 by embedding an access policy script executable by the document viewer; a web interface (not shown) for a publisher 108 to access the engine 102 via his or her computer 109; and a network connected server 112 for running the engine 102 and accessing a database 114 that stores the protected documents 116. The engine 102 interfaces with the file I/O of the server to input a clear document 104 and combine it with publisher specified document settings 106 to create the protected document 110 in a manner to be described below. The authoring component 101 allows the authoring user 108 to establish access policies that block certain functions normally accessible by the viewing user(recipients) 124, 122. For example, the author/publisher 108 may deny a viewing user privileges such as printing and copying of the clear text. The authorizing component may also establish access policies based on time or location, e.g., the document 116 may only be accessed during a certain time interval on certain computers.

The protected documents are locked for viewing but are made available to users via email, the Internet or as appropriate for a particular distribution system. In the present context, the term locked would mean any instance where the recipients rights to the document would be restricted, such as preferably, viewing or printing or copying and saving to disk. The preferred form of locking is to obscure or encrypt the content as will be described later. The authoring component 101 also includes a key repository 115 for storing encryption keys when documents are encrypted. The protected documents 116 are made available to the readers computers 122, 124 by various conventional means, including by Internet e-mail, on electronic media such as a CD-ROM, or by placing the documents on a public Internet site, available for download.

The authentication component includes an authentication server 120 and user identity database 121 for maintaining a list of users or readers 122, 124 that have or will be granted access to particular protected documents 116 by the publisher 108. The authentication component is capable of coordinating exchange of information with the various document readers 121 in order to unlock the protected documents as will be described later.

The viewing component 121 includes a number of recipients 122, 124 running a document viewer program that interacts with the documents to allow unlocking of the locked document 110. The document viewer program in addition is capable of communicating with the authentication component 119 to access the authentication server in order to unlock the document. In a preferred embodiment, the locked documents are PDF documents and the document viewer is the Adobe Acrobat reader.

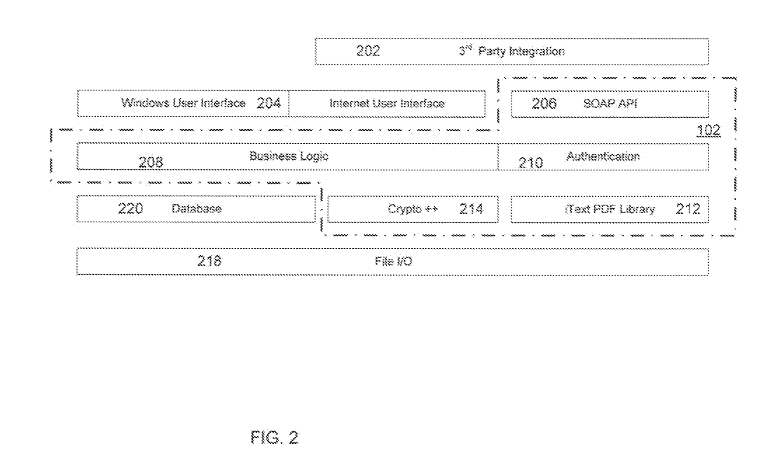

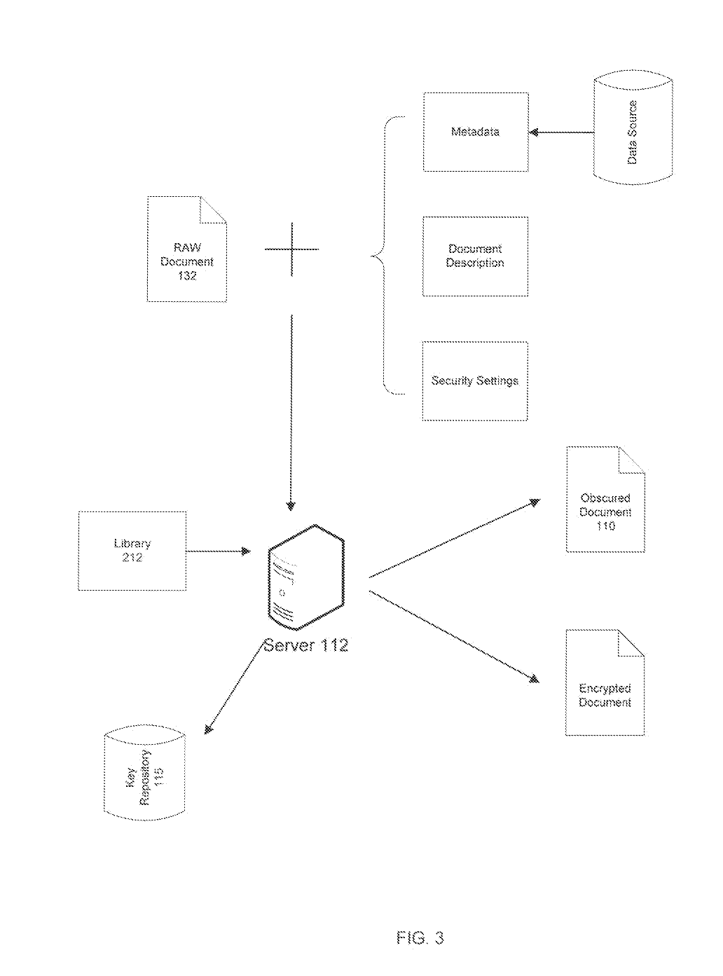

Referring to FIG. 2, the server 112 architecture is shown in more detail. The server comprises a 3 party integration module 202, such as for example a CRM system; a windows and/or Internet user interface 204, the engine 102 which includes a SOAP API 206, business logic 208, an authentication module 210 (which could be implemented on a separate authentication server as shown in FIG. 1) an iText PDF library 212 and a cryptography module 214. The iText PDF library is a library that allows users to generate PDF files on the fly; its API's and documentation are incorporated herein by reference and is available through open source. The server 112 also includes a database layer 220 for accessing data such as: document metadata; document description, document security settings and providing access to the key repository 115. A file I/O layer 218 implements the file input and output routines for reading clear text files and writing the protected files 110 to storage. A logical arrangement of these layers as they relate to the physical components that interact with the server is shown schematically in FIG. 3.

The manner of using the system 100 to create a locked document will now be described below.

The publisher 108 of a document begins with a raw file 104 containing data from a database or other data source of their choosing. Document descriptors (title, subtitle, abstract, author, author's signature, etc.) are applied as desired.

The publisher 108 also determines the security settings. Specifically, these include printing rights; a choice of obscured or encrypted, a pre-determined expiry date, an offline time limit, and the preferred encryption algorithm.

The server 112 avails itself of the library (such as the iText PDF library available through open source), to modify the raw file 104 and generate one of a series of outputs dependent on the settings chosen by the publisher.

Four possible outputs exist, as per the security settings selected by the publisher. Specifically, the outputs are documents that can be either obscured or encrypted. Two options exist for obscured documents: password protected or requiring personal contact information. Two options exist for encrypted documents: password protected or password and two-factor hardware authentication protected.

In a preferred embodiment obscured locked documents are created to include a new cover page having password or personal contact information fields and subsequent pages are obscured from view until unlocked by the document viewer. Obscuring may be achieved by placing and sizing button type control to cover each of the content pages to be obscured. The engine 102 also embeds a program code or script with the created document which is later executed by the document viewer to communicate with the authentication server 120 during authentication of the user and unlocking of the document.

If the encrypted option is chosen, the engine 102 generates a key, which is stored in the key repository 115 for future use in the decrypting process. The publisher has the option of choosing from a variety of well-known encryption algorithms. The documents remain unavailable to a recipient until decoded (see below).

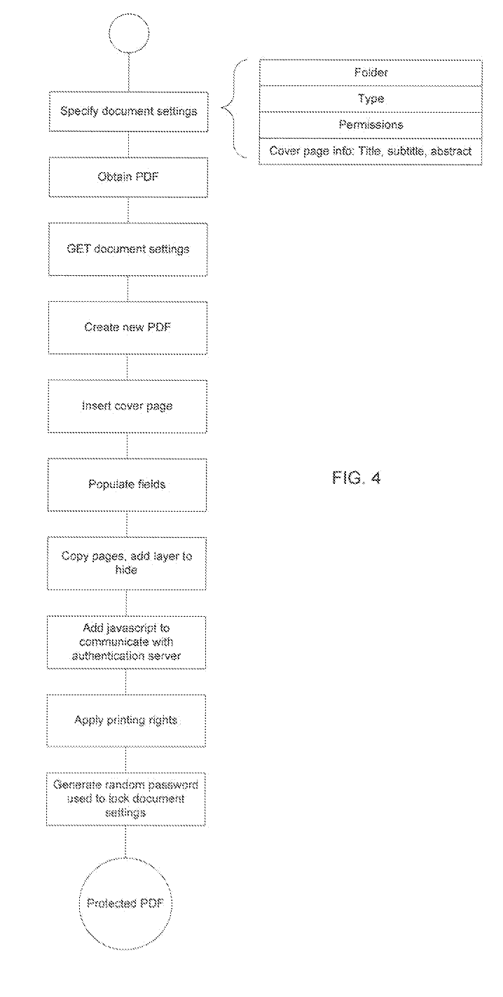

Referring to FIG. 4 there is shown the steps of creating a PDF format protected document are, as mentioned earlier the publisher 108 uses a 3 d party application to create a PDF document or has access to a PDF document. The publisher interacts with the protected PDF engine 102 through a web interface or a windows application on his computer 109. From within the interface, the publisher selects a storage location or folder where a new protected PDF document will be created. The publisher specifies the desired permissions for the file such as i. offline access (days)—this is the maximum number of consecutive days the cookie on the readers computer is valid. The cookie allows the reader to open the document without having to authenticate. A cookie is only created when a reader is authenticated. Zero days means the reader always has to authenticate. (−1) days means the reader has unlimited offline access to the file; ii printing options such as Not Allowed, Low Resolution, High Resolution Pages that are to remain unprotected (as a free sample etc). These are either Comma separated (e.g. 1,3,4,7) Ranged (e.g. 1-7) Mixed (1, 3, 4, 6-10). The user enters information for the cover page information for the document which includes (but is not limited to) a Title; a Subtitle and Abstract. The following information may also be included:

i. Cover Page Template

ii. Version (e.g. 1.0.0 or 10.2.0)

iii. Status (Inactive, Active or Retired)

iv. PDF file to be converted to protected PDF

Once all the information in entered, the publisher instructs the engine 102 to process the PDF document with the document settings as specified above. The server 112 downloads the PDF document 104 and creates a new PDF file and inserts the cover page as specified above. The document information provided is populated into fields on the cover page. The server 112 copies each page from the original PDF document 104 into the new PDF document 110. For each page, the server adds a layer hiding the contents of the page where the page is NOT specified as being excluded. The server adds a (JavaScript) code to the new PDF document. The server applies the printing rights to the PDF document (which will be honored by PDF readers such as Acrobat Reader) and generates a random password and assigns this as the owner password (so the document settings cannot be changed). The creation of the protected PDF document is thus complete.

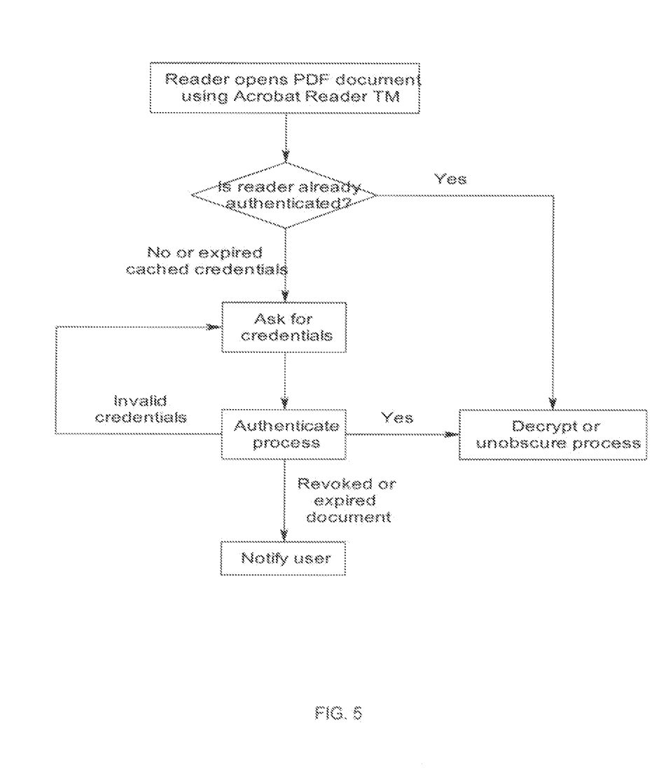

Referring now to FIG. 5 there is shown a flow chart of the decoding process. Decoding is required when a reader wishes to open a protected document that has been either obscured or encrypted as described above. It is assumed that the user has a suitable reader installed on his or her computer and that the reader's computer has access to the authentication server 119 or server 112.

Generally the process begins with the authentication of the user, caused by the execution of the code stored in the protected document. If the reader's credentials have already been authenticated, the decoding process can proceed directly to the decryption or the un-obscure procedure (see below).

If the reader's credentials have not been authenticated, or if authentication has expired, then the process proceeds to the authentication procedure. Authentication has several possible outputs as described below.

When authentication is required, the reader is requested to supply credentials. Credentials can consist of username and password alone, or can include a hardware key or ID if required, or can consist of personal contact information such as name, company, job title, address, telephone number, and email address.

When supplying credentials, which may include a user password, only the reader's username is transmitted to the authentication server. The server responds with a challenge in the form of a randomly generated number. The code embedded in the document performs a hash such as the Secure Hash Algorithm 1 (SHA-1) on the random number and the reader's password, responding to the server with a hash. The username, random number and hash are transmitted to the data source 114, where SHA-1 hash is again performed on the random number and the password as held by the data source. The data source can respond with one of four outputs; ‘Yes’, ‘No’, ‘Revoked’, or ‘Expired’. If the server receives a ‘Yes’ response, it in turn authorizes the reader's software to unobscure the PDF document (see decrypt/unobscure procedure later). A ‘No’, ‘Revoked’, or ‘Expired’ response will generate an appropriate message to be delivered to the reader, and a ‘No’ response will also request the reader to resubmit their credentials.

All transmissions between the reader, the authentication server and the data source are made over the Internet, either using secure hypertext transmission protocol (HTTPS) commands POST, GET, or simple object access protocol (SOAP) as defined by the configuration.

Throughout the authentication process, the reader's password is never transmitted over the Internet, nor ever shared with the server.

In the event that the publisher has specified that encryption must be used for security, then a Yes response from the server will include the transmission of a key to the reader.

In the event that the publisher has specified that the reader must supply personal contact information, on receipt of this information by the server, it is forwarded to the customer database used by the data source. Simultaneously, authorization to unobscure the document is returned to the document viewer. The document viewer continues to record the number of pages read, and the time spent reading them, and has the ability to transfer this information back to the server. Data obtained in the process become available to be manipulated and shared with data source providers.

Optionally, the publisher 108b may specify that the reader's contact information needs to be verified prior to un-obscuring the document. In this case, information to un-obscure the document is transmitted to an email address supplied by the reader.

The decryption and un-obscuring process may be described generally as follows:

Once a reader's credentials have been authenticated, the document can be either un-obscured or decrypted, as appropriate. To un-obscure a document, the obscuring elements are simply hidden by the document viewer. To decrypt an encrypted document, a key is used to process the file in memory. The process is not recorded or persisted in any manner.

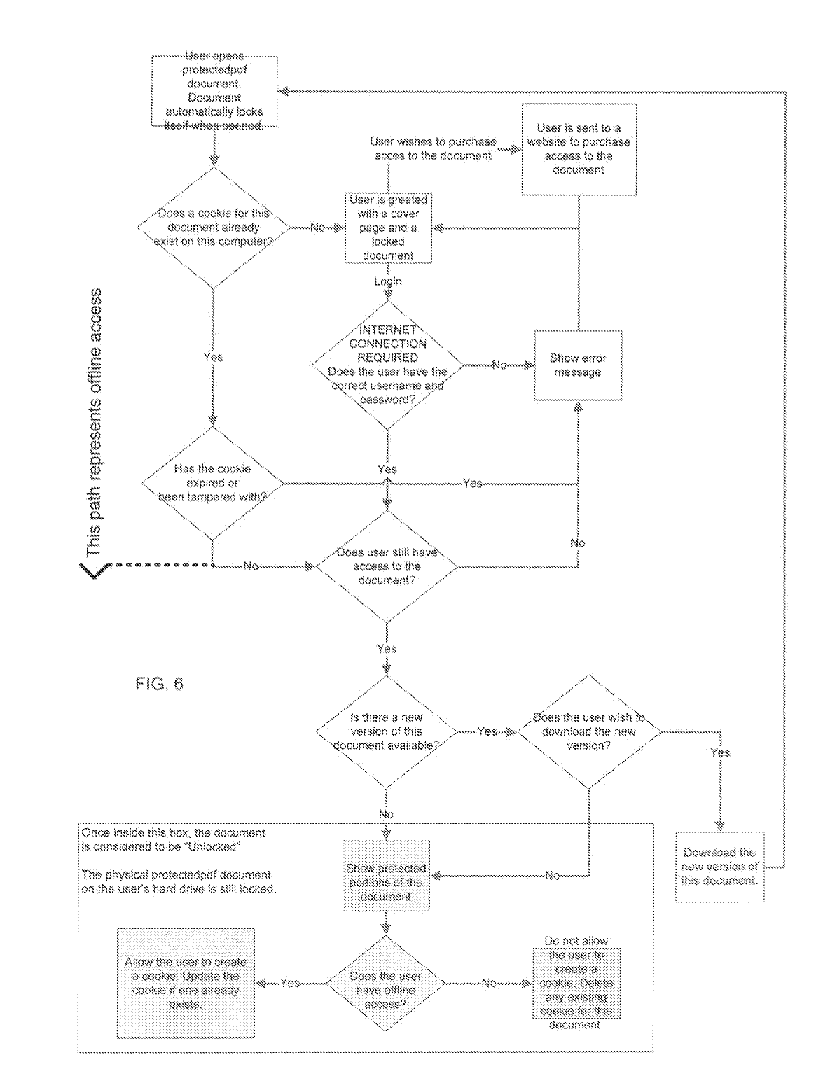

The process of unlocking a protected PDF document (using Adobe Acrobat Reader) will now be described in detail with reference to FIG. 6.
1. The user opens the protected PDF document and the document viewer executes the embedded JavaScript code that ensures that the obscuring layers are visible (i.e. hiding the contents)
2. The document viewer checks for an authentication cookie to see if the user has already been granted access to the document. If the cookie exists, the document viewer checks to ensure that the cookie has not expired. If the cookie is still valid, the document unlocks. (see step 13 below)
3. The user is greeted with the cover page and fills in their credentials. Credentials can be:

a. Email address/password

b. Username/password

c. User ID/PIN

d. Etc (as desired by the client)
4. The JavaScript code embedded in the document sends the user identifier (email address, username etc) to the server 112 or authentication server 120 using one of the following protocols:

a. HTTP

b. HTTPS

c. SOAP
5. The server 120 checks the user identifier against the identity database 121. The server generates a cryptographically strong random number (using the Microsoft crypto API) and sends the number to the protected PDF document.
6. The protected PDF document takes the random number and generates a hash using a strong hash algorithm such as MD4, MD5, SHA1 or SHA256 with the user's password as the key.
7. The protected PDF document sends the hash to the server 112.
8. The server 112 sends the user identifier, the random number and the hash code to the authentication authority.
9. The authentication authority computes a server side hash on the random number using the user's password as the key.
10. If the server side hash matches the hash computed by the protected PDF document, the user knew the correct password. The authentication authority transmits success or failure to the server 112.
11. If the authentication server reports an unsuccessful hash match, the user receives an error message.
12. If the authentication server 120 reports a successful hash match, the server 112:

a. Checks to see if the user has been granted access to the document.

b. Checks to see if the document is still active (and has not been retired)

c. Checks to see if a newer version of the document exists.

d. If all the conditions above pass, the server delivers JavaScript code for the protected PDF document Reader to hide the layer obscuring the contents of the file.

e. If there is a new version but the current version has not been retired, the user is notified of the new version but is allowed to read the document.

f. An authentication cookie is created specific to this document and the cookie's timestamp is updated.
13. Regardless of the outcome, the server logs the authentication/attempted authentication for auditing.

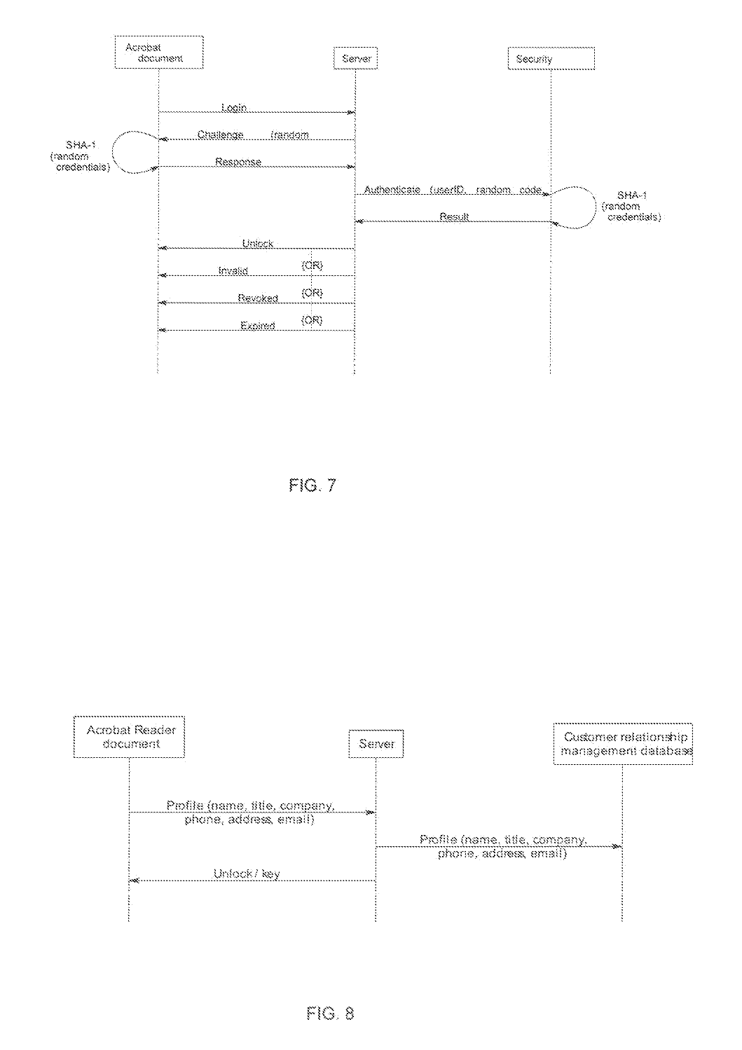

The authentication process is shown in more detail in FIG. 7.

The process for unlocking a protected-PDF document (using Adobe Acrobat Reader) for CRM purposes is described below.
1. The user opens the protected PDF document and the document ensures that the obscuring layers are visible (i.e. hiding the contents)
2. The document checks for an authentication cookie to see if the user has already been granted access to the document. If the cookie exists, the document checks to ensure that the cookie has not expired. If the cookie is still valid, the document unlocks.
3. The user fills in their contact information and any other survey questions such as Name, Title, Company, Email, Number of employees etc.
4. The JavaScript code embedded in the document sends the form data to the server 112.
5. The server adds the data to a database and notifies any 3 d party integration about the lead once it:

a. Checks to see if the document is still active (and has not been retired)

b. Checks to see if a newer version of the document exists.

c. If all the conditions above pass, the server delivers JavaScript code for the protected PDF document to hide the layer obscuring the contents of the file.

d. If there is a new version but the current version has not been retired, the user is notified of the new version but is allowed to read the document.

e. An authentication cookie is created specific to this document and the cookie's timestamp is updated.

Regardless of the outcome, the server logs the authentication/attempted authentication for auditing.

The process for creating an encrypted document according to an embodiment of the present invention is described below.
1. The publisher/author uses a 3^{rd} party application to create a PDF document.
2. Interacts with the engine 102 through a web interface (such as protectedPDF.com) or a windows application
3. From within the interface, the publisher selects a folder where the new document will be created.
4. The publisher specifies a document type
5. The publisher specifies pages that are to remain unencrypted (free sample etc). These are either

v. Comma separated (e.g. 1, 3, 4, 7)

vi. Ranged (e.g. 1-7)

vii. Mixed (1, 3, 4, 6-10)
6. The following information could for example be included::

a. Version (e.g. 1.0.0 or 10.2.0)

b. Status (Inactive, Active or Retired)

c. PDF file to be converted to protected PDF
7. The publisher submits all the information.
8. The server 112 downloads the selected PDF file 104.
9. The server 112 generates a cryptographically strong random number (key)
10. The server 112 creates a new PDF file and copies each page from the original PDF file into the new PDF file. For each page, the server finds the data stream that represents the Postscript describing the contents of that page. The server encrypts the contents of the page using an encryption algorithm such as AES or 3DES with the key generated (where the page is NOT specified in step 5)
11. The server specifies that the stream can be decrypted with a plugin that can be downloaded to run in the Reader(document viewer).
12. The creation of the protected PDF file is complete.

The process for unlocking the encrypted document (using Adobe Acrobat Reader as a document viewer) is described below.
1. The user opens the protected PDF document and Adobe Acrobat recognizes that the a decryption plug-in is required.
2. The document checks for a decryption key on the user's local machine. If a key is found, the document is unencrypted and an access log is sent to the protected PDF server. Otherwise:
3. A dialog box asks the user to fill in their credentials. Credentials can be:

a. Email address/password

b. Username/password

c. User ID/PIN

d. Etc (as desired by the client)
4. The plug-in sends the user identifier (email address, username etc) to the protected PDF server using one of the following protocols:

e. HTTP

f. HTTPS

g. SOAP
5. The server checks the user identifier against the identity database.
6. The server generates a cryptographically strong random number (using the Microsoft crypto API) and sends the number to the protected PDF file.
7. The plug-in takes the random number and generates a hash using a strong hash algorithm such as MD4, MD5, SHA1 or SHA256 with the user's password as the key.
8. The plug-in sends the hash to the server.
9. The server 112 sends the user identifier, the random number and the hash code to the authentication authority.
10. The authentication authority computes a server side hash on the random number using the user's password as the key.
11. If the server side hash matches the hash computed by the protected PDF document, the user knew the correct password. The authentication authority transmits success or failure to the server.
12. If the authentication server reports an unsuccessful hash match, the user receives an error message.
13. If the authentication server reports a successful hash match, the protected PDF server:

h. Checks to see if the user has been granted access to the document.

i. Checks to see if the document is still active (and has not been retired)

j. Checks to see if a newer version of the document exists.

k. If all the conditions above pass, the server delivers the decryption key and the current policy for the document (eg. printing allowed etc) to the plug-in.

l. The plug-in decrypts the pages as needed and enables the printing menu if allowed.

m. If there is a new version but the current version has not been retired, the user is notified of the new version but is allowed to read the document.

n. The decryption key is encrypted and stored on the user's local machine if the user has offline access.
14. Regardless of the outcome, the server logs the authentication/attempted authentication for auditing.

As will be apparent protecting a document in the manner of the present invention has applications in many fields. For example, financial institutions can securely collect personal information from clients via their website for purposes such as credit card applications. However, they lack the means to return this information to clients in a secure manner. As many credit card applications are missing pertinent data or perhaps are for the wrong product altogether, the financial institution can only decline the application or follow-up by telephone or letter mail. Both options frustrate their potential client and lead to lost sales. Using the protected PDF document as a means of delivering information to the client gives the client the opportunity to review their information on file, correct it as required, or discuss with the financial institutions personnel while both are looking at the same information.

A company can use protected PDF documents to secure company trade secrets. These can be made available to all relevant employees of the company who can access the information remotely from any computer connected to the Internet. However, should that employee leave the company, all access to the documents can be prevented, leaving valuable information secure.

In a related example, the company can also use protected PDF documents for company policies and procedures. Using the techniques described, the company can ensure that employees are always consulting the most current version of the policy, and that all employees do in fact read the policies.

A direct link to a publisher's CRM is a powerful application of this process. Exemplary uses include a financial institution marketing a new product to existing clients and being able to determine exactly who looked at the document, whether it was read in depth or not, and if it was shared with friends or family; or a consumer goods retailer placing a white paper on their website, collecting contact information for individuals reading the white paper, and then being able to contact them electronically or in person to promote relevant products.

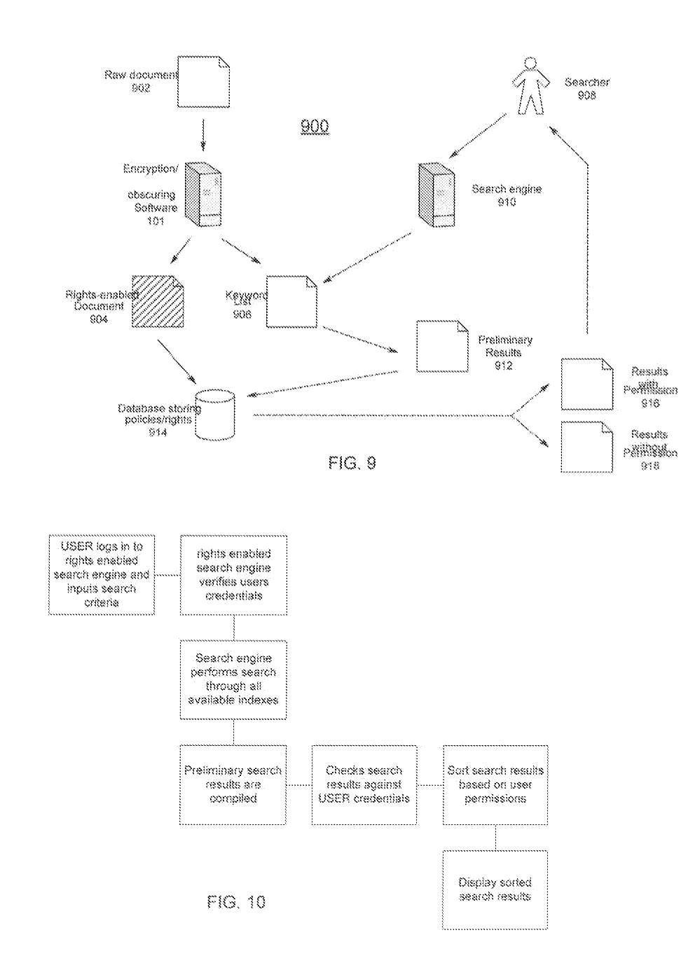

Referring now to FIG. 9 and FIG. 10 there is shown an infrastructure 900 for implementing rights enabled search process shown in FIG. 10 according to an embodiment of the present invention. The process begins with a standard raw document 902, e.g. Text file, Microsoft Word or Adobe PDF format (but not limited to). The document owner uses a tool incorporating the authoring component 101 such as described earlier with respect to FIG. 1 to protect or encrypt or obscure the document and assign to it specific rights. The document owner establishes policies and permissions related to the document, which are stored in a database. This may include a list of specific users who have access to view the document.

Two outputs are generated from the protection/encryption process: a rights-enabled document 904 and a keyword list 906. The list of keywords is generated from the document automatically as part of the encryption process. The rights-enabled document can then be published in any number of ways, including on a website, on a corporate network, etc.

At a later point in time as shown in FIG. 10, a searcher 908 identifies search criteria for a project of interest including his or her credentials. The searcher logs onto the system enters these criteria into a rights-enabled search engine 910. The search engine includes an input field for accepting a users search criteria. The users credentials may also be input at this time or may be accessed separately by the search engine 910. The rights-enabled search engine searches both publicly available documents and the keyword lists from protected documents in a chosen search domain. The search engine will be able to route requests for access to the author of the document.

A list of preliminary results (i.e. specific documents) 912 is assembled by the search engine, which then matches the documents found against the database containing document policies and permissions 914.

The list of results is separated into two components: i) those for which the searcher has permission to view 916, and ii) those for which the searcher lacks the necessary permissions to view but has the right to be aware of its existence 918. These list are then presented back to the searcher 908 and the process concludes.

The following describe example of how the embodiment of the present invention may be used. For example, a human resources division of a large privately-held company prepares numerous reports on a quarterly basis that include an analysis and interpretation of data extracted from their employee database. Examples of these include demographic analyses, use of medical benefits and sick leave, etc. Reports are placed on the corporate intranet, but are stored as protected documents in accordance with methods of the present invention that allow only human resources staff and senior executives to access them. Selected reports are made available to all management personnel in the company. Over time, the number of such reports has become extensive. Finding specific information is possible but labor-intensive.

Meanwhile, the manager of a remote division of the company is experiencing what seems to be an unusually high occurrence of back injuries among her staff. She asks a project manager within her division to investigate, including suggesting to him that he review the human resources reports. Knowing that some reports may not be available to him, the project manager initiates a rights-enabled search for the term “back injury”. He quickly finds that not only was there a human resources report on company-wide back injuries two years ago, but a separate division of the company has recently published a report that appears to document a solution to the exact problem his division has been facing. Through his supervisor, the project manager requests and is granted permissions to the relevant documents and is able to complete his work.

More likely, the user who has rights enabled would never bother doing a non-rights enabled search. The real benefit is to the publisher. Files can be put into the corporate library and both insiders and outsiders can access a search engine. The search engine is capable of managing two different user bases. Thus the web publisher does not have to worry once the file policies are set.

In another example a technology solutions firm regularly purchases research reports from leading providers in the industry. Typically the firm purchases licenses to view the encrypted reports and advises relevant staff of their availability. However, staff often do not have time to review the reports, and would instead benefit from a search capability that could locate text within reports the company has licensed.

Using the above process, staffs are able to conduct a search of all the licensed reports and quickly locate the information they desire. Additionally, they can obtain a list of available reports that the company has not bought. This has the potential of generating additional sales for the research report providers.

In another embodiment, the document is not necessarily obscured or encrypted, but simply locked subject to being unlocked by a user having the appropriate rights/ permission as stored in the rights/policies database. In this case the rights enabled search engine may be able to search all documents, regardless of the users rights, including indexes and compile the preliminary search results as before. The results are then compared against the users permissions and only the documents with the appropriate permissions are presented in the results to the user.

As will be apparent to those skilled in the art in light of the foregoing disclosure, many alterations and modifications are possible in the practice of this invention without departing from the spirit or scope thereof. The system may be configured differently by combining or splitting functions performed by the various servers, varying connections etc.

What is claimed is:

1. A method for searching documents, comprising:
a) receiving a users credentials and search criteria for searching a document repository;
b) obtaining a list of documents from said repository which satisfy said search criteria;
c) selecting from said list of documents only those for which said user has been granted permissions in accordance with said users credentials; and
d) presenting said selected list to said user.

2. A method as defined in claim 1, said documents being encrypted documents.

3. A method as defined in claim 2, including the step of generating a keyword list from said document, said keywords being made available for searching and said document being accessible to said users having permissions to access said document.

4. A system for searching documents, said system comprising:
a) a repository for storing rights enabled documents, access to said rights enabled documents being restricted based on permissions assigned to said documents;
b) a keyword list generated from said rights enabled documents, said keyword list being capable of being searched;
c) a search engine for:
i. receiving a users credentials and search criteria for searching a said keyword list;
ii. obtaining a corresponding list of documents which satisfy said search criteria;
iii. selecting from said list of documents only those for which said user has been granted permissions in accordance with said users credentials; and
iv. presenting said selected list to said user.
